(19) United States
(12) Patent Application Publication
(10) Pub. No.: US 2020/0322787 A1
(43) Pub. Date: Oct. 8, 2020

(54) COMMUNICATION SYSTEM

(71) Applicant: NEC CORPORATION, Tok yo (JP)

(72) Inventor: Sivapathalingham SIVAVAKEESAR, Milton Keynes (GB)

(73) Assignee: NEC CORPORATION, Tokyo (JP)

(21) Appl. No.: 16/303,897

(22) PCT Filed: May 22, 2017
(86) PCT No.: PCT/JP2017/019074

§ 371 Date: Nov. 21, 2018

(30) Foreign Application Priority Data
May 23, 2016 (GB) 1609052.4

(51) Int. Cl. H04W 8/26; H04L 29/12

(52) U.S. Cl. CPC H04W 8/26; H04W 84/042; H04L 61/6063

(57) ABSTRACT

A system is disclosed in which a base station obtains i) an identifier for identifying a base station and/or a cell and ii) a tracking area code associated with an area in which a plurality of base stations/cells operate including the base station/cell to which the identifier relates. The base station is configured to use the obtained identifier in combination with the tracking area code for uniquely identifying the base station/cell in a subsequent procedure relating to that base station/cell.

### TECHNICAL FIELD

The present invention relates to a communication system. The invention has particular but not exclusive relevance to wireless communication systems and devices thereof operating according to the 3rd Generation Partnership Project (3GPP) standards or equivalents or derivatives thereof. The invention has particular although not exclusive relevance to automatic neighbour relation procedures and procedures in which a base station and/or a cell thereof needs to be uniquely identified.

### BACKGROUND ART

The latest developments of the 3GPP standards are referred to as the Long Term Evolution (LTE) of Evolved Packet Core (EPC) network and Evolved UMTS Terrestrial Radio Access Network (E-UTRAN). Under the 3GPP standards, a NodeB (or an eNB in LTE) is the base station via which communication devices connect to a core network and communicate to other communication devices or remote servers. The term macro eNB refers to base stations having one or more macro cells (cells that cover a relatively large geographical area) whilst the term small cell refers to a cell that covers a relatively small geographical area (e.g. a home or office and/or the like) often overlapping with a macro cell. A small cell (or pico cell) may be operated by a small cell eNB or home eNB (HeNB) and/or the like. However, such small cells are also often controlled—indirectly—by a macro eNB, e.g. the macro base station that operates the macro cell with which the small cell overlaps. Therefore, at least in the case of macro base stations, a single base station may operate and/or control a large number of cells, for example, a maximum of 256 cells per base station in current LTE systems. For simplicity, the present application will use the term base station to refer to any such base stations.

Each base station is associated with a unique base station identifier (such as an ‘eNB-ID’ and/or the like). The base station identifier (which may form part of, or be the same as, a corresponding cell identifier) can be used to uniquely identify each individual cell. When a cell identifier is combined with a network identifier (e.g. a public land mobile network (PLMN) identifier) it can provide substantially unique identification on a global level. As described in section 8.2 of 3GPP Technical Specification (TS) 36.300 V13.3.0, the so-called E-UTRAN Cell Global Identifier (ECGI) may be used to identify cells globally. The ECGI of each cell is constructed from an identifier of the public land mobile network (PLMN) that the cell belongs to and the cell identity (CI) of that cell (within that PLMN). In E-UTRAN, the cell identity comprises 28 bits and it is known as the E-UTRAN cell identity (ECI). In case of macro cells (and small cells controlled by a macro base station), each (E)CI includes (as the left 20 bits) the eNB ID of the macro base station that controls that cell.

Communication devices might be, for example, mobile communication devices such as mobile telephones, smartphones, user equipment, personal digital assistants, laptop/tablet computers, web browsers, e-book readers and/or the like. Such mobile (or even generally stationary) devices are typically operated by a user. However, 3GPP standards also make it possible to connect so-called ‘Internet of Things’ (IoT) devices (e.g. Narrow-Band IoT (NB-IoT) devices) to the network, which typically comprise automated equipment, such as various measuring equipment, telemetry equipment, monitoring systems, tracking and tracing devices, in-vehicle safety systems, vehicle maintenance systems, road sensors, digital billboards, point of sale (POS) terminals, remote control systems and the like. It will be appreciated that IoT devices are sometimes also referred to as Machine-Type Communication (MTC) communication devices or Machine-to-Machine (M2M) communication devices. For simplicity, the present application refers to mobile devices in the description but it will be appreciated that the technology described can be implemented on any communication devices (mobile and/or generally stationary) that can connect to a communications network for sending/receiving data, regardless of whether such communication devices are controlled by human input or software instructions stored in memory.

Thus, there is a need to provide cellular services over large areas (by way of deploying more and more macro base stations) and a demand for an increasing number of small cells (such as home eNBs and similar) for serving a growing number of communication devices (via more and more cells). In the future, mobile networks are expected to be able to support more than 4 million base stations per operator and to control up to 1024 cells per base station (compared to the currently standardised 256 cells per base station).

These needs present a significant challenge for mobile operators wishing to maintain a globally unique base station identifier (eNB-ID) and cell identifier for each base station/cell in their network.

A straightforward solution to this problem would be to increase the number of bits used for the base station identifier and/or cell identifier, which would allow each operator to avoid having to re-use the same base station identifier and cell identifier for different base station/cell combinations. However, this would result in a backward compatibility problem, because a large number of mobile devices and base stations (and/or other network nodes) only support earlier versions of the relevant standards and hence they would not be able to understand such new ‘extended’ base station identifiers and cell identifiers (or they would be able to understand only a part of the extended identifier, which would still cause ambiguity and potential conflict between different base station/cell combinations).

3GPP considered (although not standardised) two options to address the issue of increasing the base station identifier beyond the currently standardised 20 bits and the issue of increasing the number of cells per base station beyond 256.

According to a first option considered by 3GPP, the total number of bits used to construct the ECGI (28 bits) remains unchanged, but the number of bits to denote the eNB-ID (within the ECGI) can be changed flexibly, between 18 and 21 bits, depending on operator needs. Effectively, this solution involves moving the boundary in the ECGI by the value ‘N’ such that the eNB-ID uses 20+N bits, while the Cell ID uses 8-N bits.

However, flexibly changing the eNB-ID within a constant length ECGI may still cause interoperability issues. For example, different nodes may be configured to use different number of bits to indicate the eNB-ID (within the ECGI).

Moreover, each eNB having an extended (i.e. more than 20 bits) eNB-ID would have much less cells compared to the currently possible 256. Therefore, this solution does not meet the objectives set by 3GPP and does not allow operators to increase both the number of eNBs and the number of cells concurrently. This is clearly in conflict with current trends that base stations are getting more and more powerful and control more cells, especially when carrier aggregation (CA) is also employed. This solution may have significant impacts on the radio access network (RAN) and other parts of the network, including, but not limited to: the S1 Application Protocol (S1AP) and the X2 application protocol (X2AP); Public Warning System (PWS) functionality; emergency services with cell knowledge; Location Services (LCS); handover; X2 setup; and/or the like.

Having an extended eNB-ID would also make it very complicated (or even impossible) to comply with the requirements set in Annex 2.2 of TS 25.401 V13.0.0, which discloses (as Rules 1 to 4) complex rules for network configuration when employing an extended radio network controller identifier (RNC-ID) scheme (for example, the provision of an extended RNC-ID for a radio network controller forming part of an eNB).

This problem is even more serious in LTE, due to the emergence of IOT.

### SUMMARY OF INVENTION

### Technical Problem

Another option considered by 3GPP was to use more than one PLMN identifier per mobile operator, which would also allow each operator to have additional ECGIs without having to change the CI (as the ECGI is constructed from the PLMN ID and the CI). However, this option would most likely require a change of Universal Subscriber Identity Modules (USIMs) and hence it was objected to by network operators due to the associated cost and inconvenience to their subscribers. Furthermore, the operators' requirement is to increase the number of unique eNB-IDs within a single network (i.e. for the same PLMN-ID).

It is therefore difficult to meet the competing demands of operators to increase the number of base stations and cells in their networks while maintaining uniqueness of each cell within their networks and without causing backward compatibility problems.

Accordingly, preferred embodiments of the present invention aim to provide methods and apparatus which address or at least partially deal with the above issues.

Although for efficiency of understanding for those of skill in the art, the invention will be described in detail in the context of a 3GPP system (UMTS, LTE), the principles of the invention can be applied to other systems in which a large number of base stations and cells are deployed.

### Solution to Problem

In one aspect, the invention provides communication apparatus for a communication network, the communication apparatus comprising a controller configured to: obtain i) an identifier for identifying at least one of a base station and a cell operated by the base station and ii) a tracking area code associated with an area in which a plurality of base stations operate including the base station to which the identifier relates; and use the obtained identifier in combination with the tracking area code for identifying the base station in a subsequent procedure relating to that base station.

Aspects of the invention extend to corresponding systems, methods, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

FIG. 1 illustrates schematically a cellular telecommunication system to which example embodiments of the invention may be applied;

FIG. 2 is a block diagram of a an exemplary way in which automatic neighbour relations may be managed by a base station forming part of the system shown in FIG. 1;

FIG. 3 is a block diagram of a mobile device forming part of the system shown in FIG. 1;

FIG. 4 is a block diagram of a base station forming part of the system shown in FIG. 1;

FIG. 5 is a block diagram of a mobility management entity forming part of the system shown in FIG. 1;

FIG. 6 is a timing diagram illustrating an exemplary way in which an example embodiment of the invention can be implemented in the system of FIG. 1;

FIG. 7 is a timing diagram illustrating an exemplary way in which an example embodiment of the invention can be implemented in the system of FIG. 1; and

FIG. 8 is a timing diagram illustrating an exemplary way in which an example embodiment of the invention can be implemented in the system of FIG. 1.

### DESCRIPTION OF EMBODIMENTS

### Overview

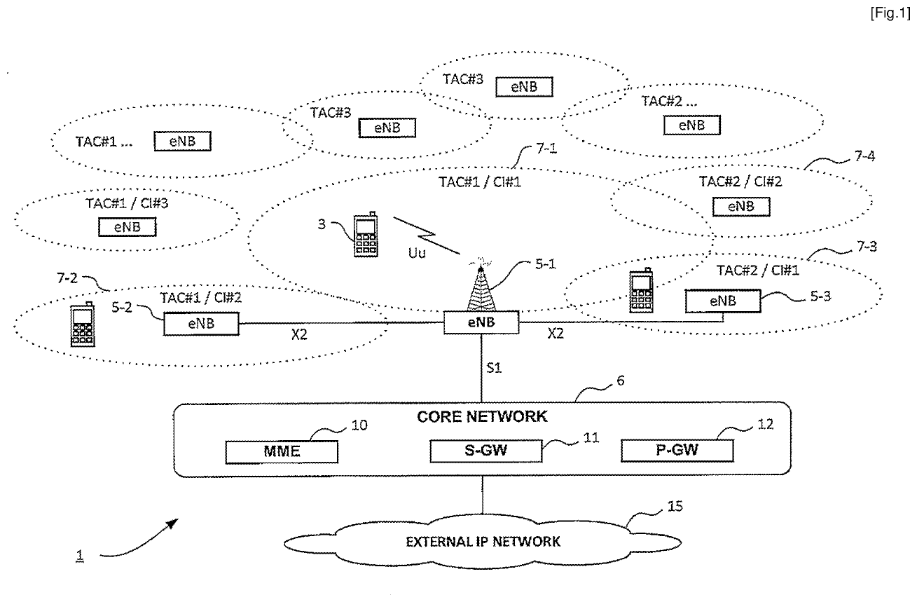

FIG. 1 schematically illustrates a telecommunications network 1 in which mobile devices 3 (mobile telephones and/or other user equipment) can communicate with each other via base stations 5 (e.g. LTE base stations or ‘eNBs’) and a core network 6 using an appropriate E-UTRA radio access technology (RAT). As those skilled in the art will appreciate, whilst three mobile devices 3 and nine base stations 5 are shown in FIG. 1 for illustration purposes, the system, when implemented, will typically include other base stations and communication devices.

Each base station 5 operates one or more associated cells 7. Mobile devices connect to an appropriate cell 7 (depending on their location and possibly on other factors, e.g. signal conditions, subscription data, capability, and/or the like) by establishing a radio resource control (RRC) connection with the base station 5 operating that cell 7.

The core network 6 includes (amongst other things) a mobility management entity (MME) 10 and one or more gateways, such as a serving gateway (S-GW) 11 and a packet data network (PDN) gateway (P-GW) 12.

The MME 10 is the network node responsible for keeping track of the locations of the mobile devices 3 within the communications network 1, and for assisting the serving base station 5 in configuring the communication bearers used by mobile devices 3 in the base station's cell(s) 7. The MME 10 keeps track of the locations of the mobile devices 3 on a tracking area (TA) level, e.g. by storing an appropriate tracking area code (TAC) associated with the last known cell 7 where the mobile device 3 was located. The TAC, together with the PLMN identifier, forms a tracking area identifier (TAI). Although not shown in FIG. 1, the core network 6 may also include one or more of the following nodes: an operation and maintenance (O&M) entity; a home subscriber server (HSS); an application server (AS); a multimedia broadcast/multicast service (MBMS) server; a multi-cell/multicast coordination entity (MCE); an evolved serving mobile location centre (E-SMLC); and/or the like.

Each base station 5 is connected to the core network 6 via an S1 interface and neighbouring base stations 5 are connected to each other via an X2 interface (either directly or via an X2 gateway). Connection between the core network 6 and other networks 15 and/or servers hosted outside the core network 6 is provided via the P-GW 12. Such other (external) networks 15 may include Internet Protocol (IP) networks, such as the Internet and/or wireless local area networks (WLANs). When a particular base station is connected to a WLAN, the base station and nodes (e.g. access points) of the WLAN are coupled via an Xw interface provided between the base station and a WLAN termination (WT) node in the WLAN.

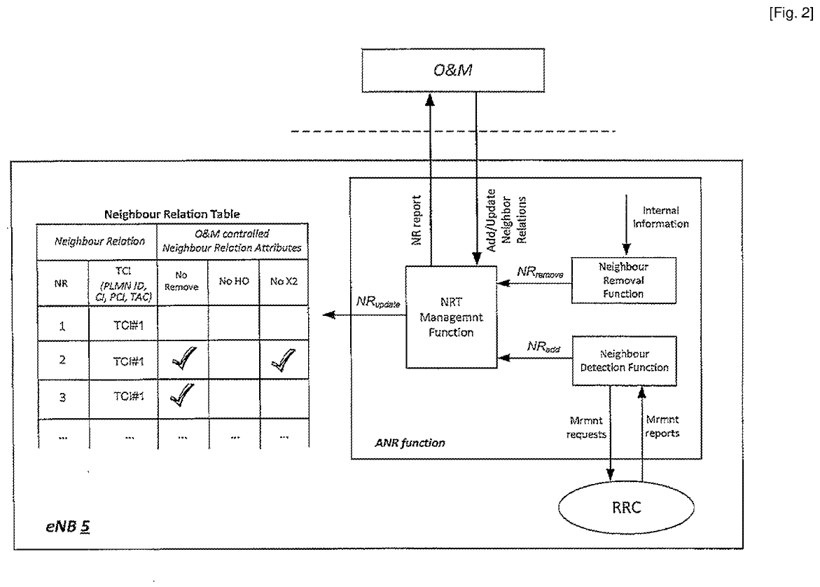

The telecommunications network 1 makes beneficial use of Automatic Neighbour Relation (ANR) functionality. Therefore, each base station 5 is configured to store and maintain an appropriate neighbour relations table (NRT) for each cell 7 operated by that base station. Further details of the ANR functionality and the NRT will be given below with reference to FIG. 2.

In the example shown in FIG. 1, for illustration purposes, each base station 5 is associated with a single cell 7 (base station 5-1 operates cell 7-1, base station 5-2 operates cell 7-2, base station 5-3 operates cell 7-3, etc.). However, when implemented, each macro base station will typically control and/or be associated with a plurality of cells (e.g. up to 256 or 1024 cells per eNB).

Each cell 7 is associated with an appropriate cell identifier (CI) and a TAC (or TAI). In current LTE systems, the cell identifier consists of 28 bits (binary), the left 20 bits of which make up the base station identifier (eNB ID) which is used for identifying a particular base station within a public land mobile network (PLMN), such as the telecommunications network 1. The telecommunications network 1 is also associated with a (binary) PLMN identifier (PLMN ID). The so-called E-UTRAN Cell Global Identifier (ECGI) is used to identify a particular cell 7 globally and the ECGI is constructed from the CI associated with that cell 7 and the appropriate PLMN ID associated with the PLMN in which that cell 7 is located. The ECGI has a binary value with a maximum of 52 bits.

Each base station 5 is configured to broadcast, via appropriate system information broadcast (SIB), in each cell 7 associated with that particular base station 5, the PLMN ID, CI, and TAC associated with that cell 7. Beneficially, in this telecommunications network 1 (i.e. for the same PLMN ID), the same CI may be re-used in each tracking area (although, preferably, no CI is re-used within the same tracking area). Thus, in each tracking area (i.e. for the same TAC value), each cell 7 is configured with a different CI to other cells 7 in that tracking area.

As can be seen in FIG. 1, the mobile device 3 is currently served by the base station 5-1 via a cell having a tracking area code #1 and a cell identifier #1. However, cell 7-3 (controlled by base station 5-3) has the same cell identifier #1 but a different tracking area code #2. Similarly, in this telecommunications network 1, any CI already used in tracking area #1 and/or #2 may also be re-used in other tracking areas, such as tracking area #3 (although none of the CIs are re-used within the same tracking area). In other words, each cell 7 within the network 1 can be uniquely identified using a combination of its cell identifier and tracking area code.

Beneficially, the nodes of this system are configured to uniquely identify each particular cell 7 using a combination of the CI (or related base station identifier, e.g. eNB ID/HeNB ID) and the TAC (or CI+TAC+PLMN ID/eNB ID+TAC+PLMN ID) rather than, for example, the CI/eNB ID alone.

For example, the base station 5-1 is configured to uniquely identify its cell 7-1 (and any further cell operated by the base station 5-1) using the CI and TAC associated with cell 7-1 (e.g. within the telecommunications network 1) and/or using the CI and TAC and PLMN ID (e.g. globally), rather than using the CI or ECGI alone. It will be appreciated that the base stations 5 and other nodes of this system 1 may be configured to identify a particular cell 7 using its associated CI together with its TAC and/or to identify a particular base station 5 using its associated eNB ID together with its TAC in procedures where previously only the CI/eNB ID may have been used. By way of example, these procedures include (but are not limited to): an automatic neighbour relation (ANR) procedure, an operation and maintenance (O&M) procedure, an X2 procedure, an Xw procedure, an S1 procedure, an M2 procedure, and an E-SMLC procedure.

In more detail, in case of an ANR (or O&M) procedure, the base station 5-1 is configured to obtain the CI/eNB ID and TAC associated with each neighbouring cell 7, and to store the obtained CI/eNB ID in association with the TAC in an appropriately formatted ANR table managed by the base station 5-1, for use in uniquely identifying that cell 7/eNB 5.

The base station 5 is also configured to provide the CI/eNB ID together with the TAC associated with a particular cell 7/eNB 5 (e.g. in a dedicated information element pair) to other nodes during procedures performed by the base station 5 relating to that particular cell 7 (e.g. the base station's 5 own cell or a neighbour cell).

For example, the base station 5 may be configured to provide the CI/TAC pair (or eNB ID/TAC pair) associated with a particular cell 7 (for uniquely identifying that cell 7) to a neighbouring base station in an X2 procedure (e.g. procedures such as handover/mobility, X2 release, X2 removal request/response, X2AP message transfer (e.g. the ‘RNL Header’ thereof), X2 setup, load information, resource status, cell activation, radio link failure, and/or the like).

The base station 5 may also be configured to uniquely identifying a particular cell 7 (e.g. its own cell) by providing the CI/TAC pair (or eNB ID/TAC pair) associated with that cell 7 to: the MME10 in an S1 procedure; a WLAN termination (WT) node in an Xw procedure; a multi-cell/multicast coordination entity (MCE) in an M2 procedure; and an evolved serving mobile location centre (E-SMLC) in an E-SMLC procedure.

Beneficially, therefore, in any procedure where eNB ID (or global eNB ID) and/or cell ID (or global cell ID) is used in signalling messages (such as S1AP, M2AP, X2AP, XwAP signalling messages), the signalling messages also include, together with the cell ID/eNB ID, the TAC/TAI associated the base station and/or cell to which that procedure/signalling message relates to.

The combined use of CI/eNB ID and TAC, which were previously used for different purposes, allows unique identification of each cell/base station without requiring a change of any existing parameters (e.g. to change the number of bits associated with the eNB ID) and/or introducing new parameters (e.g. new PLMN IDs). This solution therefore allows an increase in both the number of base stations and the number of cells in the network while maintaining global uniqueness of each cell and minimising backward compatibility problems compared to other solutions.

Automatic Neighbour Relation

Manually provisioning and managing neighbour cells in traditional mobile network is a challenging task and it becomes more difficult as new mobile technologies are being rolled out while ‘legacy’ 2G/3G cells already exist. For LTE (or ‘4G’) operators, this is a challenging task, as in addition of defining intra LTE neighbour relations for their (LTE) base stations, they also need to consider neighbour cells operated under other standards (e.g. 2G, 3G, CDMA2000 cells and/or the like).

As described in 3GPP TS 36.300 V13.3.0 section 22.3.2a, the purpose of the Automatic Neighbour Relation (ANR) function is to relieve the operator from the burden of manually managing Neighbour Relations (NRs). FIG. 2 is a block diagram of a an exemplary way in which automatic neighbour relations may be managed by one of the base stations 5 in the system 1 shown in FIG. 1.

For each cell, the base station keeps a conceptual Neighbour Relation Table (NRT). As can be seen, the ANR function resides in the base station and includes appropriate functionality for managing the NRT (per cell).

The so-called Neighbour Detection Function is responsible for finding new neighbours and adding them to the NRT (in this example, via the NRT management function). This is normally performed by the base station configuring appropriate cell measurements for one or more mobile devices served by the base station, and receiving corresponding measurement reports from the mobile devices including information identifying the measured cells. When the measurement reports identify a cell which is not listed in the NRT (for the given cell), the Neighbour Detection Function (via the NRT management function) adds this cell to the NRT (after appropriate communication with other nodes, if necessary).

The so-called Neighbour Removal Function is responsible for removing outdated neighbour relations (NRs). The Neighbour Detection Function and the Neighbour Removal Function are implementation specific, and may thus differ from base station to base station.

In addition, the neighbour information exchange between two base stations (e.g. during the X2 Setup procedure or the eNB Configuration Update procedure) may also be used for ANR purposes. The ANR function also allows the network operator to manage the NRT via an operation and maintenance (O&M) function. The operator can use the O&M function for manually adding, deleting NRs, and/or changing the attributes of the NRT, if appropriate. The ANR function may also inform the O&M system about changes in the NRT (e.g. about changes that are not made via the O&M function).

In order for the mobile devices to uniquely identify the source of a received signal, each base station is given a signature sequence referred to as a Physical Cell ID (PCI) or a ‘physical-layer cell identity’. The PCI is defined by: the carrier frequency and the Primary Scrambling Code (PSC) in case of UTRAN Frequency Division Duplex (FDD) cell; the carrier frequency and the cell parameter ID in case of UTRAN Time Division Duplex (TDD) cell; the Band Indicator+Base Station Identity Code (BSIC)+Broadcast Control Channel (BCCH) Absolute Radio Frequency Channel Number (ARFCN) in case of a GSM EDGE Radio Access Network (GERAN) cell; and the pseudorandom noise (PN) offset in case of CDMA2000 cell.

For each NR, the NRT usually includes an associated Target Cell Identifier (TCI), which identifies that cell as a target cell (e.g. for handover or other signalling). In current E-UTRAN systems, the TCI corresponds to the E-UTRAN Cell Global Identifier (ECGI) and the PCI. Therefore, in conventional ANR implementations, a Neighbour Relation (NR) from a source cell to a target cell means that the base station controlling the source cell: a) knows the ECGI/CI and the PCI of the target cell; b) has an entry in the NRT for the source cell identifying the target cell; and c) the attributes in this Neighbour Relation Table entry have been defined (for example, by O&M or set to default values).

However, in this system 1, for each neighbour cell the NRT includes the following information: an associated PLMN ID; an associated CI (or ECGI=PLMN ID+CI); an associated PCI; and an associated TAC. In other words, in this system, a Neighbour Relation (NR) from a source cell to a target cell means that the base station controlling the source cell knows the ECGI/CI, PCI, and TAC of the target cell.

In this system 1, the ANR function relies on each cell broadcasting its associated PLMN ID, global level identity (i.e. ECGI), PCI, and TAC. The ANR function of a base station is configured to instruct mobile devices to perform measurements on neighbour cells. When a mobile device sends a measurement report relating to a neighbour cell, the initial report includes the neighbour cell's PCI. In response to receiving the PCI, the base station may proceed to carry out the following procedure.

The serving base station can instruct the mobile device, using the newly discovered PCI as parameter, to read the ECGI, TAC, and all available PLMN ID(s) of the corresponding neighbour cell. When the mobile device has found out the new cell's ECGI (e.g. as specified in 3GPP TS 36.331 V13.1.0), the mobile device reports the detected ECGI to the serving base station. However, in this case the mobile device also reports the TAC (and all PLMN IDs) for that neighbour cell. If the base station decides to add this neighbour relation, it can use the reported PCI, ECGI, together with TAC to uniquely identify a cell/base station perform at least one of the following:
a) lookup a transport layer address to a new base station;
b) update the Neighbour Relation List; and
c) if needed, setup a new X2 interface towards another base station.

Beneficially, therefore, by using the TAC in combination with the CI/ECGI/eNB ID the same number of bits may be used for the CI/ECGI/eNB ID whilst enabling the nodes of the system 1 shown in FIG. 1 to support and distinguish between a larger number of base stations and cells than conventional ANR implementations relying on the ECGI only.

Mobile Device

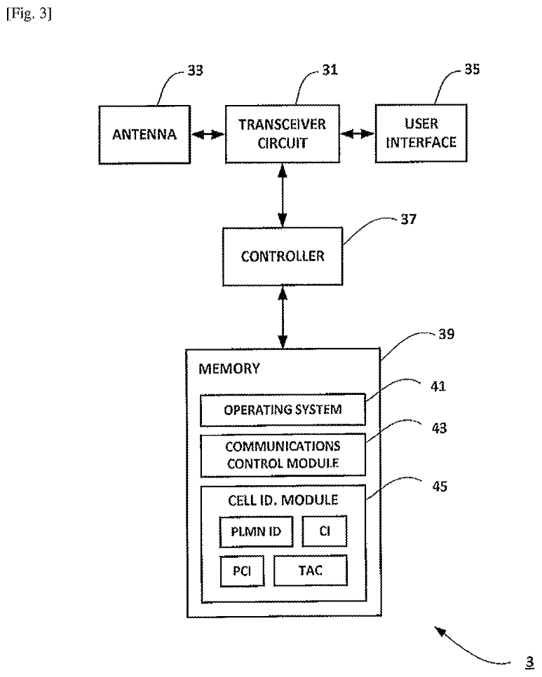

FIG. 3 is a block diagram illustrating the main components of the mobile device 3 shown in FIG. 1 (e.g. a mobile telephone or other user equipment). As shown, the mobile device 3 has a transceiver circuit 31 that is operable to transmit signals to and to receive signals from a base station 5 via one or more antenna 33. The mobile device 3 has a controller 37 to control the operation of the mobile device 3. The controller 37 is associated with a memory 39 and is coupled to the transceiver circuit 31. Although not necessarily required for its operation, the mobile device 3 might of course have all the usual functionality of a conventional mobile telephone 3 (such as a user interface 35) and this may be provided by any one or any combination of hardware, software and firmware, as appropriate.

Software may be pre-installed in the memory 39 and/or may be downloaded via the telecommunications network or from a removable data storage device (RMD), for example. The controller 37 is configured to control overall operation of the mobile device 3 by, in this example, program instructions or software instructions stored within the memory 39. As shown, these software instructions include, among other things, an operating system 41, a communications control module 43, and a cell identification module 45.

The communications control module 43 is operable to control the communication between the mobile device 3 and its serving base station 5 (and other communication devices connected to the serving base station 5, such as further mobile devices and/or network nodes).

The cell identification module 45 is responsible for storing information for uniquely identifying each cell 7 (at least those cells 7 that are in the vicinity of the mobile device 3). As can be seen, the cell identification module 45 stores, for each cell 7, an appropriate PLMN ID associated with that cell 7, a CI associated with that cell 7, a PCI associated with that cell 7, and a TAC associated with that cell 7. In other words, the mobile device 3 is configured to use the CI or the ECGI (which is made up of the PLMN ID and the CI) together with the TAC associated with a particular cell 7 for uniquely identifying that cell 7.

Base Station

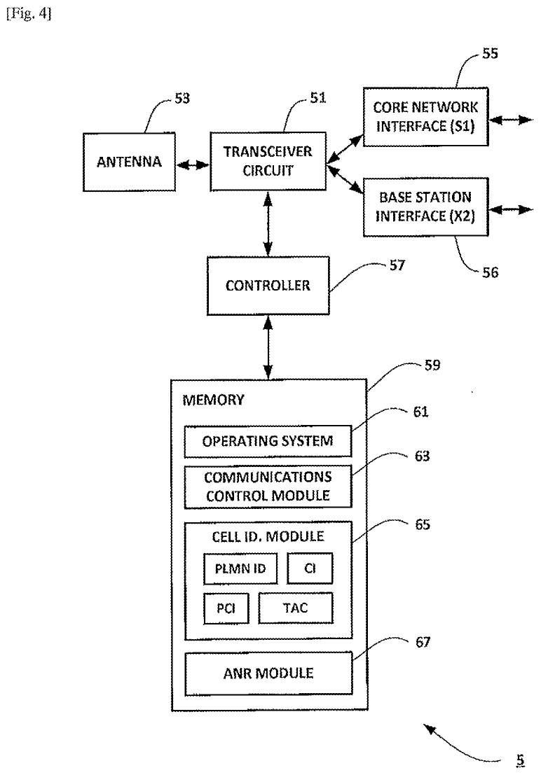

FIG. 4 is a block diagram illustrating the main components of a base station 5 shown in FIG. 1. As shown, the base station 5 has a transceiver circuit 51 for transmitting signals to and for receiving signals from the communication devices (such as mobile devices 3/user equipment) via one or more antenna 53, a core network interface 55 (e.g. an S1 interface) for transmitting signals to and for receiving signals from the core network (e.g. MME 10), and a base station interface 56 (e.g. an X2 interface) for transmitting signals to and for receiving signals from neighbouring base stations. The base station 5 has a controller 57 to control the operation of the base station 5. The controller 57 is associated with a memory 59. Although not necessarily shown in FIG. 4, the base station 5 will of course have all the usual functionality of a cellular telephone network base station and this may be provided by any one or any combination of hardware, software and firmware, as appropriate. Software may be pre-installed in the memory 59 and/or may be downloaded via the communications network 1 or from a removable data storage device (RMD), for example. The controller 57 is configured to control the overall operation of the base station 5 by, in this example, program instructions or software instructions stored within the memory 59. As shown, these software instructions include, among other things, an operating system 61, a communications control module 63, a cell identification module 65, and an ANR module 67.

The communications control module 63 is operable to control the communication between the base station 5 and mobile devices 3 (user equipment) and other network entities that are connected to the base station 5. The communications control module 63 also controls the separate flows of downlink user traffic (via associated data radio bearers) and control data to be transmitted to communication devices associated with this base station 5.

The cell identification module 65 is responsible for storing information for uniquely identifying each cell 7 (e.g. the base station's own cell(s) and/or cells of its neighbour base stations). As can be seen, the cell identification module 65 stores, for each cell 7, an appropriate PLMN ID associated with that cell 7, a CI associated with that cell 7, a PCI associated with that cell 7, and a TAC associated with that cell 7. In other words, the base station 5 is configured to use the CI or the ECGI (which is made up of the PLMN ID and the CI) together with the TAC associated with a particular cell 7 for uniquely identifying that cell 7.

The ANR module 67 is responsible for procedures relating to automatic neighbour relations, including obtaining an appropriate CI (or ECGI) and TAC associated with each neighbour cell 7. The ANR module 67 is responsible for providing the CI (or ECGI) together with the TAC associated with a particular cell 7 to other nodes during procedures performed by the base station 5 relating to that particular cell 7, in order to uniquely identify that cell 7.

Mobility Management Entity

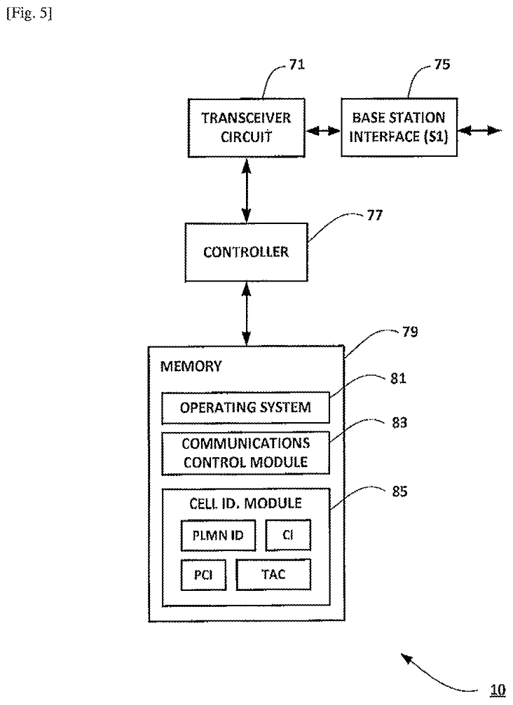

FIG. 5 is a block diagram illustrating the main components of the mobility management entity (MME) 10 shown in FIG. 1. As shown, the MME 10 has a transceiver circuit 71 for transmitting signals to and for receiving signals from the base stations 5 (and/or communication devices connected to the base stations 5) via a base station interface 75 (e.g. an S1 interface). The MME 10 has a controller 77 to control the operation of the MME 10. The controller 77 is associated with a memory 79. Although not necessarily shown in FIG. 5, the MME 10 will of course have all the usual functionality of a cellular telephone network mobility management entity and this may be provided by any one or any combination of hardware, software and firmware, as appropriate. Software may be pre-installed in the memory 79 and/or may be downloaded via the communications network 1 or from a removable data storage device (RMD), for example. The controller 77 is configured to control the overall operation of the MME 10 by, in this example, program instructions or software instructions stored within the memory 79. As shown, these software instructions include, among other things, an operating system 81, a communications control module 83, and a cell identification module 85.

The communications control module 83 is operable to control the communication between the MME 10 and the base stations 5 (including mobile devices 3 connected to the base stations 5) and other network entities that are connected to the MME 10.

The cell identification module 85 is responsible for storing information for uniquely identifying each cell 7 within the area managed by the MME 10. As can be seen, the cell identification module 85 stores, for each cell 7, an appropriate PLMN ID associated with that cell 7, a CI associated with that cell 7, a PCI associated with that cell 7, and a TAC associated with that cell 7. In other words, the MME 10 is configured to uniquely identify each respective cell 7 using the CI or ECGI (which is made up of the PLMN ID and the CI) of that cell 7 together with the TAC associated with that particular cell 7.

In the above description, the mobile device 3, the base station 5, and the mobility management entity 10 are described for ease of understanding as having a number of discrete modules (such as the communications control modules, the ANR module, and the cell identification modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

In the following, a more detailed description will be given (with reference to FIGS. 5 to 8) of some exemplary procedures in which the CI of a cell can be used together with the TAC of that cell for uniquely identifying the cell. Similarly, a combination of eNB-ID and TAC can be used to increase the number of unique eNB-IDs within a network (e.g. for the same PLMN ID).

Operation

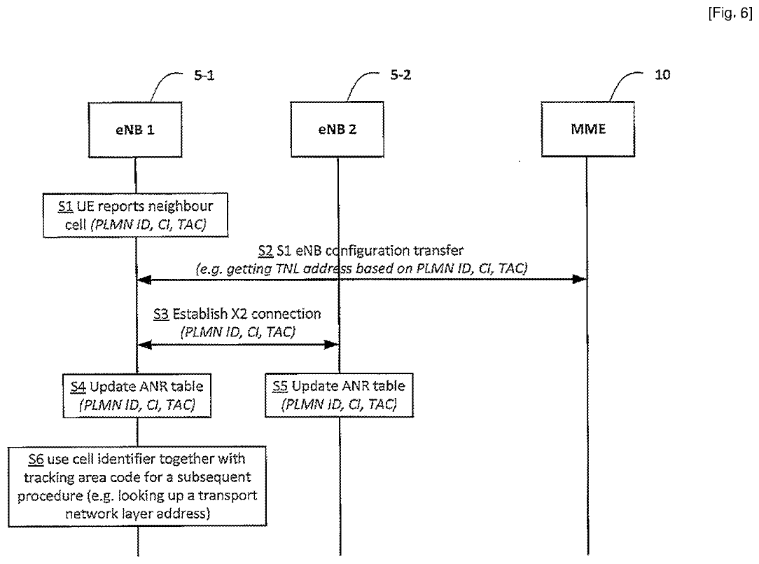

FIG. 6 is a timing diagram (message sequence chart) illustrating an example process performed by components of the system 1 when performing an ANR procedure for setting up a neighbour relation (and X2 connection) between neighbouring base stations (eNB) 5-1 and 5-2.

Initially, a mobile device (UE) 3 served by the first base station 5-1 sends a measurement report relating to a new neighbour cell (e.g. cell 7-2 controlled by base station 5-2). As generally shown in step S1, e.g. upon request by the serving base station 5-1, the mobile device 3 reports the PLMN ID, CI (or ECGI), and TAC of the neighbour cell 7-2.

In response to this, the serving base station 5-1 can proceed to updating its ANR table (using its ANR module 67), as generally shown in step S4. In order to do so, the base station 5-1 may communicate with the MME 10, for example, by sending an appropriately formatted S1 signalling message, such as an ‘eNB Configuration Transfer’ message and include in this message the CI (or ECGI) together with the TAC of the neighbour cell 7-2 towards which the base station 5-1 wants to set up an X2 connection. Therefore, in this case, the base station's 5-1 eNB Configuration Transfer message uniquely identifies the target cell by its associated CI and TAC (rather than the CI alone). The MME 10 is thus able to look up the appropriate address of the base station 5-2 controlling the identified cell 7-2 and send an appropriate S1 MME Configuration Transfer to the base station 5-1.

Using the information included in the MME's 10 response (e.g. a transport network layer address for the neighbour base station 5-2 and/or the like), the base station 5-1 and the neighbour base station 5-2 can proceed to establish, in step S3, an appropriate X2 connection with each other. During the X2 connection establishment, the base stations 5-1 and 5-2 are configured to identify each other by their associated eNB ID and TAC and identify each other's cells by their associated CI and TAC.

If appropriate, the neighbour base station 5-2 can also update its ANR table, as shown in step S5, and include in its ANR table any cell controlled by the base station 5-1 as a new neighbour cell (in this example, cell 7-1).

Beneficially, therefore, by using the CI together with the TAC, the nodes of the system are able to uniquely distinguish between different cells having the same cell identifier (e.g. cells 7-2 and 7-4, both of which are neighbours of base station 5-1) and thereby avoid any conflict in subsequent handling of these cells.

For example, the CI and TAC of a particular cell 7 may be used together for uniquely identifying that cell 7 in a subsequent procedure including (but not limited to): an ANR procedure, an O&M procedure, an X2 procedure, an Xw procedure, an S1 procedure, an M2 procedure, and an E-SMLC procedure.

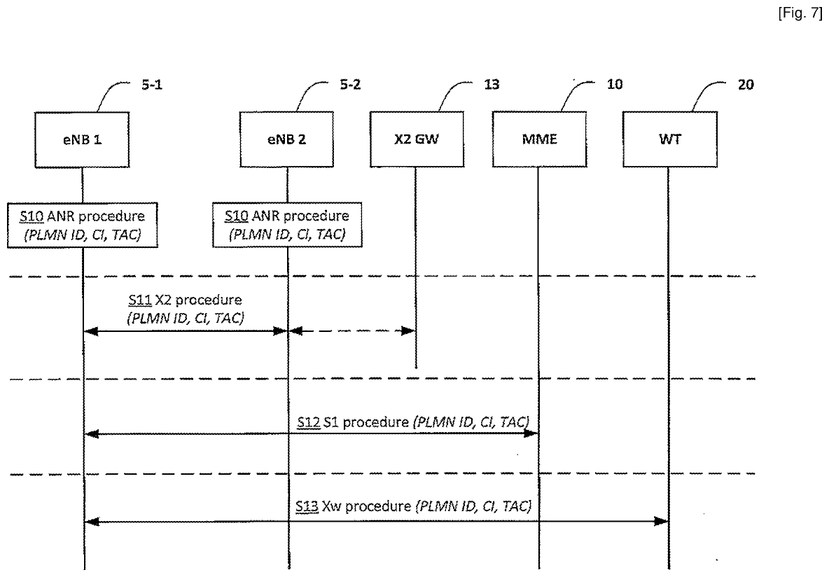

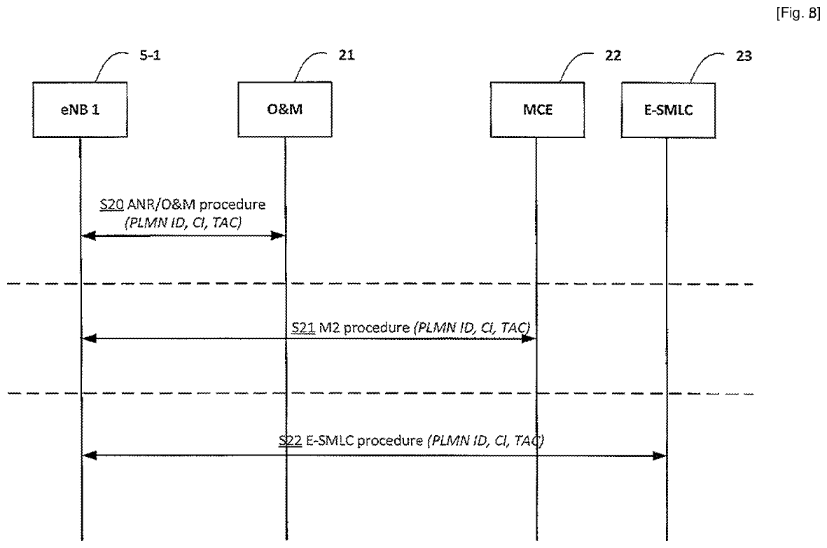

FIGS. 7 and 8 illustrate some exemplary procedures (and/or in signalling messages relating to such procedures) in which a CI together with the TAC may be used to identify a cell and/or an eNB ID can be used together with the TAC to identify a base station.

It will be appreciated that the steps shown in FIGS. 7 and 8 may be preceded by step S6 (FIG. 6) in which the base station 5-1 involved in the procedure uses the cell identifier (or base station identifier) together with the tracking area code for identifying a particular cell (or base station) for carrying out the subsequent procedure. For example, the base station 5-1 may be configured to look up a transport network layer address for its neighbour base station 5-2 before sending an X2 signalling message to that base station 5-2.

As generally shown in step S10 of FIG. 7, the base stations 5 may be configured to use the TAC together with the CI (or ECGI=PLMN ID+CI) of a particular cell 7 in a subsequent ANR procedure (NR removal, NR report, etc.).

The base stations 5 may also be configured to use the TAC and CI (or ECGI) of a particular cell 7 in a subsequent X2 procedure (step S11) to identify that cell 7, including but not limited to: handover request, handover report, X2 release, X2 removal, load information, resource status, RLF indication, and cell activation procedure. Alternatively, or in addition, the base stations 5 may be configured to use the TAC and eNB-ID (or global eNB-ID) of a particular base station in such an X2 procedure to identify the base station 5. Further details and information elements (IEs) relating to various exemplary X2 procedures in which the TAC and CI/eNB-ID (or ECGI/global eNB-ID) may be used for identifying a cell/base station are given in Tables 1 to 23 below. It will be appreciated that the base stations 5 may be connected (and hence exchange X2 signalling messages with each other) via an X2 gateway (X2 GW) 13. In this case, the X2 GW 13 may also be configured to identify individual cells by their associated CI and TAC and/or to identify each base station 5 with a combination of its associated eNB ID and TAC.

As illustrated in step S12, the base stations 5 may also be configured to use the TAC and CI (or ECGI) of a particular cell 7 in a subsequent S1 procedure, for example, a public warning system (PWS) procedure and/or the like, in which a cell needs to be uniquely identified (and/or to use the TAC and eNB-ID (or global eNB-ID) of a base station 5 to uniquely identify that base station in such procedures).

As generally illustrated in step S13, each base station 5 may also be configured to use the TAC and CI (or ECGI) in a subsequent Xw procedure towards a WLAN, for example, for uniquely identifying a particular cell 7 of that base station 5 for a WLAN termination (WT) node 20 of the WLAN during establishment (setup) of an Xw connection. Alternatively, or in addition, the base stations 5 may be configured to use the TAC and eNB-ID (or global eNB-ID) of a particular base station in such an Xw procedure to identify the base station 5.

As shown in step S20 of FIG. 8, the base stations 5 may also be configured to use the TAC and CI (or ECGI=PLMN ID+CI) of a particular cell 7 for identifying that cell in a subsequent ANR procedure performed with an operation and maintenance (O&M) node 21 (e.g. NR report, update parameters, and/or the like).

As generally illustrated in step S21, each base station 5 may also be configured to use the TAC and CI (or ECGI) in a subsequent M2 procedure towards an multi-cell/multicast coordination entity (MCE) 22, for example, for uniquely identifying a particular cell 7 of that base station 5 in an M2 setup and/or a configuration update procedure. Alternatively, or in addition, the base stations 5 may be configured to use the TAC and eNB-ID (or global eNB-ID) of a particular base station in such an M2 procedure to identify the base station 5.

As generally illustrated in step S22, each base station 5 may also be configured to uniquely identifying a particular cell 7 of that base station 5 using its associated TAC and CI (or ECGI) in a subsequent procedure towards an E-SMLC 23. Alternatively, or in addition, the base stations 5 may be configured to use their TAC and eNB-ID (or global eNB-ID) in such an E-SMLC procedure to identify the base station 5.

Further details and information elements (IEs) relating to various exemplary procedures in which the eNB-ID/CI (or ECGI) of a base-station/cell may be beneficially used together with the TAC for identifying the base-station/cell are given in Tables 24 to 29.

### Modifications and Alternatives

Detailed example embodiments have been described above. As those skilled in the art will appreciate, a number of modifications and alternatives can be made to the above example embodiments whilst still benefiting from the inventions embodied therein. By way of illustration only a number of these alternatives and modifications will now be described.

In steps S1 to S22 of FIGS. 6 to 8, the nodes are shown to use the PLMN ID, the CI, and the TAC associated with a particular cell/base station in order to uniquely identify that cell/base station. However, it will be appreciated that:
the TAC of an eNB may be used in combination with the eNB-ID to uniquely identify that eNB within an operator network;
the TAC of an eNB may be used in combination with the ECI to uniquely identify an E-UTRAN cell within an operator network; and/or
the TAC of an eNB may be used in combination with the ECGI to uniquely identify an E-UTRAN cell globally.

In the above example embodiments, the base station uses a 3GPP radio communications (radio access) technology to communicate with the mobile device. However, any the base station and the mobile device may be configured to communicate with each other using any other suitable radio communications technology (i.e. WLAN, Wi-Fi, WiMAX, Bluetooth, etc.). The above example embodiments are also applicable to ‘non-mobile’ or generally stationary user equipment.

In the above description, the mobile device, the base station, and the MME are described for ease of understanding as having a number of discrete functional components or modules. Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the base station, to the mobility management entity, or to the mobile device as a signal over a computer network, or on a recording medium. Further, the functionality performed by part or all of this software may be performed using one or more dedicated hardware circuits. However, the use of software modules is preferred as it facilitates the updating of the base station, the mobility management entity, or the mobile device in order to update their functionalities.

Tables 1 to 29 illustrate some of the possible procedures and information elements in which the TAC (and/or eNB ID) combined with the CI may be used in order to uniquely identify a particular cell (and/or base station). In the following tables, the TAC is included in the form of a list of tracking area identifiers (TAIs). Therefore, TAC and TAI are used interchangeably. It will be appreciated that the list of TAIs may comprise a single TAI.

X2 Procedures—Tables 1 to 23

TABLE 1
HANDOVER REQUEST
(This message is sent by the source eNB to the target eNB to request the
preparation of resoumes for a handover. Direction: source eNB → target eNB)

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.2.13 | | YES | reject |
| Old eNB UE X2AP ID | M | | eNB UE | Allocated at the source | YES | reject |
| | | | X2AP ID | eNB | | |
| | | | 9.2.24 | | | |
| Cause | M | | 9.2.6 | | YES | ignore |
| Target Cell ID | M | | ECGI | | YES | reject |
| | | | 9.2.14 | | | |
| Target TAC | M | | OCTET | Tracking Area | YES | reject |
| | | | STRING | Code | | |
| | | | (2) | | | |
| GUNIMEI | M | | 9.2.16 | | YES | reject |
| UE Context | | 1 | | | YES | reject |
| Information | | | | | | |
| >MME UE S1AP ID | M | | INTEGER | MME UE S1AP ID | — | — |
| | | | (0.2³²-1) | allocated at the MME | | |
| >UE Security | M | | 9.2.29 | | — | — |
| Capabilities | | | | | | |
| >AS Security | M | | 9.2.30 | | — | — |
| Information | | | | | | |
| >UE Aggregate | M | | 9.2.12 | | — | — |
| Maximum Bit Rate | | | | | | |
| >Subscriber Profile ID | O | | 9.2.25 | | — | — |
| for RAT/Frequency | | | | | | |
| priority | | | | | | |
| >E-RABs To Be | | 1 | | | — | — |
| Setup List | | | | | | |
| >>E-RABs To Be | | 1.. | | | EACH | ignore |
| Setup Item | | <maxnoof | | | | |
| | | Bearers> | | | | |
| >>>E-RAB ID | M | | 9.2.23 | | — | — |
| >>>E-RAB Level | M | | 9.2.9 | Includes necessary | — | — |
| QoS Parameters | | | | QoS parameters | | |
| >>>DL | O | | 9.2.5 | | — | — |
| Forwarding | | | | | | |
| >>>UL GTP | M | | GTP | SGW endpoint of the | — | — |
| Tunnel Endpoint | | | Tunnel | S1 transport bearer, For | | |
| | | | Endpoint | delivery of UL PDUs. | | |
| | | | 9.2.1 | | | |
| >RRC Context | M | | OCTET | Includes the RRC | — | — |
| | | | STRING | Handover Preparation | | |
| | | | | Information message as | | |
| | | | | defined in subclause | | |
| | | | | 10.2.2 of TS 36.331 | | |
| >Handover | O | | 9.2.3 | | — | — |
| Restriction List | | | | | | |
| >Location Reporting | O | | 9.2.21 | Includes the necessary | — | — |
| Information | | | | parameters for location | | |
| | | | | reporting | | |
| >Management Based | O | | 9.2.59 | | YES | ignore |
| MDT Allowed | | | | | | |
| >Management | O | | MDT | | YES | ignore |
| Based MDT PLMN | | | PLMN List | | | |
| List | | | 9.2.64 | | | |
| UE History Information | M | | 9.2.38 | Same definition as in | YES | ignore |
| | | | | TS 36.413 | | |
| Trace Activation | O | | 9.2.2 | | YES | ignore |
| SERVCC, Operation | O | | 9.2.33 | | YES | ignore |
| Possible | | | | | | |
| CSG Membership | O | | 9.2.52 | | YES | reject |
| Status | | | | | | |
| Mobility Information | O | | BIT | information related to | YES | ignore |
| | | | STRING | the handover the | | |
| | | | (SIZE (32)) | source eNB provides it | | |
| | | | | in order to enable later | | |
| | | | | analysis of the | | |
| | | | | conditions that led to a | | |
| | | | | wrong HO. | | |
| Masked IMEISV | O | | 9.2.69 | | YES | ignore |
| UE History Information | O | | OCTET | VisitedCellinfoList | YES | ignore |
| from the UE | | | STRING | contained in the | | |
| | | | | UEInformationResponse | | |
| | | | | message (TS 36.331) | | |
| Expected UE Behaviour | O | | 9.2.70 | | YES | ignore |
| ProSe Authorized | O | | 9.2.78 | | YES | ignore |
| UE Context Reference | O | | | | YES | ignore |
| at the SeNB | | | | | | |
| >Global SeNB ID | M | | Global | | | |
| | | | eNB ID | | | |
| | | | 9.2.22 | | | |
| >SeNB TAI | | | | | | |
| >SeNB UE X2AP ID | M | | eNB UE | Allocated at the SeNB | | |
| | | | X2AP ID | | | |
| | | | 9.2.24 | | | |
| >SeNB UE X2AP ID | O | | Extended | Allocated at the SeNB | | |
| Extension | | | eNB UE | | | |
| | | | X2AP ID | | | |
| | | | 9.2.86 | | | |
| Old eNB UE X2AP ID | O | | Extended | Allocated at the source | YES | reject |
| Extension | | | eNB UE | eNB | | |
| | | | X2AP ID | | | |
| | | | 9.2.86 | | | |

| Range bound | Explanation |
|---|---|
| maxnoofBearers | Maximum no. of E-RABs. Value is 256 |
| maxnoofMDTPLMNs | PLMNs in the Management Based MDT PLMN list. Value is 16. |

TABLE 2
X2 RELEASE
(This message is used to indicate that the signalling connection to an eNB is
unavailable. Direction: eNB₁ → eNB₂)

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| Global eNB ID | M | | 9.2.22 | | YES | reject |
| List of TAIs | | 1 | | | YES | ignore |
| >TAI List Item | | 1.. | | | EACH | ignore |
| | | <maxnoofTAIs> | | | | |
| >>TAI | M | | 9.2.3.xx | | — | |

TABLE 3
X2 REMOVAL REQUEST
(This message is sent by an eNB to a neighbouring eNB to initiate the removal of
the signaling connection. Direction: eNB₁ → eNB₂)

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| Global eNB ID | M | | 9.2.22 | | YES | reject |
| List of TAIs | | 1 | | | YES | ignore |
| >TAI List Item | | 1.. | | | EACH | ignore |
| | | <maxnoofTAIs> | | | | |
| >>TAI | M | | 9.2.3.xx | | — | |

TABLE 4
X2 REMOVAL RESPONSE
(This message is sent by an eNB to a neighbouring eNB to acknowledge the
initiation of removal of the signaling connection. Direction: eNB₂ → eNB₁)

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| Global eNB ID | M | | 9.2.22 | | YES | reject |
| List of TAIs | | 1 | | | YES | ignore |
| >TAI List Item | | 1.. | | | EACH | ignore |
| | | <maxnoofTAIs> | | | | |
| >>TAI | M | | 9.2.3.xx | | — | |
| Criticality | O | | 9.2.7 | | YES | ignore |
| Diagnostics | | | | | | |

TABLE 5
RNL Header
(The RNL Header IE indicates the target eNB ID and source eNB ID.)

| | | | IE type and | Semantics | | Assigned |
|---|---|---|---|---|---|---|
| IE/Group Name | Presence | Range | reference | description | Criticality | Criticality |
| Source eNB ID | M | | Global eNB | | — | — |
| | | | ID 9.2.22 | | | |
| List of TAIs of | | 1 | | | YES | ignore |
| Source eNB Id | | | | | | |
| >TAI List | | 1.. | | | EACH | ignore |
| Item | | <maxnoofTAIs> | | | | |
| >>TAI | M | | 9.2.3.xx | | — | |
| Target eNB ID | O | | Global eNB | | — | — |
| | | | ID 9.2.22 | | | |
| List of TAIs of | | 1 | | | YES | ignore |
| Target eNB ID | | | | | | |
| >TAI List | | 1.. | | | EACH | ignore |
| Item | | <maxnoofTAIs> | | | | |
| >>TAI | M | | 9.2.3.xx | | — | |

TABLE 6
HANDOVER REQUEST
(This message is sent by the source eNB to the target eNB to request the
preparation of resources for a handover. Direction: source eNB → target eNB)

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| Old eNB UE | M | | eNB UE | Allocated at the source | YES | reject |
| X2AP ID | | | X2AP ID | eNB | | |
| | | | 9.2.24 | | | |
| Cause | M | | 9.2.6 | | YES | ignore |
| Target Cell ID | M | | ECGI | | YES | reject |
| | | | 9.2.14 | | | |
| Target TAC | | | | | | |
| GUMMEI | M | | 9.2.16 | | YES | reject |

TABLE 7
LOAD INFORMATION
(This message is sent by an eNB to neighbouring eNBs to transfer load and
interference co-ordination information. Direction: eNB₁ → eNB₂)

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | ignore |
| Cell Information | M | | | | YES | ignore |
| >Cell Information Item | | 1.. | | | EACH | ignore |
| | | <maxCellineNB> | | | | |
| >>Cell ID | M | | ECGI | Id of the source cell | — | — |
| | | | 9.2.14 | | | |
| >>TAC | | | | | | |
| >>UL Interference | O | | 9.2.17 | | — | — |
| Overload Indication | | | | | | |
| >>UL High | | 0.. | | | — | — |
| Interference | | <maxCellineNB> | | | | |
| Information | | | | | | |
| >>>Target Cell ID | M | | ECGI | Id of the cell for | — | — |
| | | | 9.2.14 | which the HII is | | |
| | | | | meant | | |
| >>>Target TAC | | | | | | |
| >>>UL High | M | | 9.2.18 | | — | — |
| Interference Indication | | | | | | |

TABLE 8
eNB Configuration Update-AAS Additions

| | | | IE type and | Semantics | | Assigned |
|---|---|---|---|---|---|---|
| IE/Group Name | Presence | Range | reference | description | Criticality | Criticality |
| Served Cells To | | 0.. | | Complete list of | GLOBAL | reject |
| Modify | | <maxCellineNB> | | modified cells served | | |
| | | | | by the eNB | | |
| >Old ECGI | M | | ECGI | Old E-UTRAN Cell | — | — |
| — | | | 9.2.14 | Global Identifier | | |
| >Old TAC | | | | | | |
| Coverage | | 0.. | | List of cells with | GLOBAL | reject |
| Modification List | | <maxCellineNB> | | modified coverage | | |
| >ECGI | M | | ECGI | E-UTRAN Cell Global | | |
| | | | 9.2.14 | Identifier of the cell to | | |
| | | | | be modified | | |
| >TAC | | | | | | |
| >Cell Coverage | M | | INTEGER | Value ‘0’ indicates that | — | — |
| State | | | (0..15, . . . ) | the cell is inactive. | | |
| | | | | Other values Indicates | | |
| | | | | that the cell is active | | |
| | | | | and also indicates the | | |
| | | | | coverage configuration | | |
| | | | | of the concerned cell | | |
| >Cell | O | | ENUMERATED | Indicates the Cell | | |
| Deployment | | | (pre- | Coverage State is | | |
| Status Indicator | | | change- | planned to be used at | | |
| | | | notification, | the next reconfiguration | | |
| | | | . . . ) | | | |
| >Cell Replacing | C- | | | | | |
| info | ifCellDeployment | | | | | |
| | StatusIndicator | | | | | |
| | Present | | | | | |
| >>Replacing | | 0.. | | | | |
| Cells | | <maxCellineNB> | | | | |
| >>>ECGI | | | ECGI | E-UTRAN Cell Global | | |
| | | | 9.2.14 | Identifier of a cell that | | |
| | | | | may replace all or part | | |
| | | | | of the coverage of the | | |
| | | | | cell to be modified | | |
| >>>TAC | | | | | | |

TABLE 9
RESOURCE STATUS REQUEST

| | | | IE type and | Semantics | | Assigned |
|---|---|---|---|---|---|---|
| IE/Group Name | Presence | Range | reference | description | Criticality | Criticality |
| Cell To Report | | 1 | | Cell ID list for which | YES | ignore |
| | | | | measurement is needed | | |
| >Cell To | | 1.. | | | EACH | ignore |
| Report Item | | <maxCellineNB> | | | | |
| >>Cell ID | M | | ECGI | | — | — |
| | | | 9.2.14 | | | |
| >>TAC | | | | | | |

TABLE 10
RESOURCE STATUS RESPONSE

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| eNB1 Measurement | M | | INTEGER | Allocated by eNB₁ | YES | reject |
| ID | | | (1..4095, . . . ) | | | |
| eNB2 Measurement | M | | INTEGER | Allocated by eNB₂ | YES | reject |
| ID | | | (1..4095, . . . ) | | | |
| Criticality Diagnostics | O | | 9.2.7 | | YES | ignore |
| Measurement | | 0..1 | | List of all cells in which | YES | ignore |
| Initiation Result | | | | measurement objects | | |
| | | | | were requested, | | |
| | | | | included when | | |
| | | | | indicating partial | | |
| | | | | success | | |
| >Measurement | | 1.. | | | EACH | ignore |
| Initiation Result | | <maxCellineNB> | | | | |
| Item | | | | | | |
| >>Cell ID | M | | ECGI | | — | — |
| | | | 9.2.14 | | | |
| >>TAC | | | | | | |
| >>Measurement | | 0..1 | | Indicates that eNB₂ | — | — |
| Failure Cause | | | | could not initiate the | | |
| List | | | | measurement for at | | |
| | | | | least one of the | | |
| | | | | requested | | |
| | | | | measurement objects | | |
| | | | | in the cell | | |

TABLE 11
RESOURCE STATUS FAILURE

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| eNB1 Measurement | M | | INTEGER | Allocated by eNB₁ | YES | reject |
| ID | | | (1..4095, . . . ) | | | |
| eNB2 Measurement | M | | INTEGER | Allocated by eNB₂ | YES | reject |
| ID | | | (1..4095, . . . ) | | | |
| Cause | M | | 9.2.6 | Ignored by the receiver | YES | ignore |
| | | | | when the Complete | | |
| | | | | Failure Cause | | |
| | | | | Information IE is | | |
| | | | | included | | |
| Criticality Diagnostics | O | | 9.2.7 | | YES | ignore |
| Complete Failure | | 0..1 | | Complete list of failure | YES | ignore |
| Cause Information | | | | causes for all | | |
| | | | | requested cells | | |
| >Complete Failure | | 1.. | | | EACH | ignore |
| Cause Information | | <maxCellineNB> | | | | |
| Item | | | | | | |
| >>Cell ID | M | | ECGI | | — | — |
| | | | 9.2.14 | | | |
| >>TAG | | | | | | |
| >>Measurement | | 1 | | | — | — |
| Failure Cause | | | | | | |
| List | | | | | | |

TABLE 12
RESOURCE STATUS UPDATE
(This message is sent by eNB₂ to neighbouring eNB₁ to report the results of the
requested measurements. Direction: eNB₂ → eNB₁)

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | ignore |
| eNB1 Measurement | M | | INTEGER | Allocated by eNB₁ | YES | reject |
| ID | | | (1..4095, . . . ) | | | |
| eNB2 Measurement | M | | INTEGER | Allocated by eNB₂ | YES | reject |
| ID | | | (1..4095, . . . ) | | | |
| Cell Measurement | | 1 | | | YES | ignore |
| Result | | | | | | |
| >Cell Measurement | | 1.. | | | EACH | ignore |
| Result Item | | <maxCellineNB> | | | | |
| >>Cell ID | M | | ECGI | | | |
| | | | 9.2.14 | | | |
| >>TAC | | | | | | |
| >>Hardware Load | O | | 9.2.34 | | | |
| Indicator | | | | | | |

TABLE 13
MOBILITY CHANGE REQUEST
(This message is sent by an eNB₁ to neighbouring eNB₂ to initiate
adaptation of mobility parameters. Direction: eNB₁ → eNB₂)

| IE/ | | | IE type | | | Assigned |
|---|---|---|---|---|---|---|
| Group | | | and | Semantics | Criti- | Criti- |
| Name | Presence | Range | reference | description | cality | cality |
| Message | M | | 9.2.13 | | YES | reject |
| Type | | | | | | |
| eNB1 | M | | ECGI | | YES | reject |
| Cell ID | | | 9.2.14 | | | |
| TAC | | | | | | |
| eNB2 | M | | ECGE | | YES | reject |
| Cell ID | | | 9.2.14 | | | |
| TAC | | | | | | |
| eNB1 | O | | Mobility | Configuration | YES | ignore |
| Mobility | | | Parameters | change | | |
| Parameters | | | Information | in eNB₁ cell | | |
| | | | 9.2.48 | | | |
| eNB2 | M | | Mobility | Proposed | YES | reject |
| Proposed | | | Parameters | configuration | | |
| Mobility | | | Information | change in | | |
| Parameters | | | 9.2.48 | eNB₂ cell | | |
| Cause | M | | 9.2.6 | | YES | reject |

TABLE 14
MOBILITY CHANGE ACKNOWLEDGE
(This message is sent by the eNB₂ to indicate that the eNB₂
Proposed Mobility Parameter proposed by
eNB₁ was accepted. Direction: eNB₂ → eNB₁)

| IE/ | | | IE type | | | Assigned |
|---|---|---|---|---|---|---|
| Group | Pres- | | and | Semantics | Criti- | Criti- |
| Name | ence | Range | reference | description | cality | cality |
| Message | M | | 9.2.13 | | YES | reject |
| Type | | | | | | |
| eNB1 | M | | ECGI | | YES | reject |
| Cell ID | | | 9.2.14 | | | |
| eNB1 TAC | | | | | | |
| eNB2 | M | | ECGI | | YES | reject |
| Cell ID | | | 9.2.14 | | | |
| eNB2 TAC | | | | | | |
| Criticality | O | | 9.2.7 | | YES | ignore |
| Diagnostics | | | | | | |

TABLE 15
MOBILITY CHANGE FAILURE
(This message is sent by the eNB₂ to indicate that the eNB₂ Proposed
Mobility Parameter proposed by eNB₁ was refused.
Direction: eNB₂→eNB₁)

| | | | IE type | | | Assigned |
|---|---|---|---|---|---|---|
| IE/Group | Pres- | | and | Semantics | Criti- | Criti- |
| Name | ence | Range | reference | description | cality | cality |
| Message Type | M | 9.2.13 | | | YES | reject |
| eNB1 Cell ID | M | ECGI | | | YES | ignore |
| | | 9.2.14 | | | | |
| eNB1 TAC | | | | | | |
| eNB2 Cell ID | M | ECGI | | | YES | ignore |
| | | 9.2.14 | | | | |
| eNB2 TAC | | | | | | |
| Cause | M | 9.2.6 | | | YES | ignore |
| Mobility | O | 9.2.49 | | | YES | ignore |
| Parameters | | | | | | |
| Modification | | | | | | |
| Range | | | | | | |
| Criticality | O | 9.2.7 | | | YES | ignore |
| Diagnostics | | | | | | |

TABLE 16
RLF INDICATION
(This message is sent by the eNB₂ to indicate an RRC re-establishment attempt or a reception
of an RLF Report from a UE that suffered a connection failure at eNb₁. Direction: eNB₂ → eNB₁)

| | | | IE type and | | | Assigned |
|---|---|---|---|---|---|---|
| IE/Group Name | Presence | Range | reference | Semantics description | Criticality | Criticality |
| Message Type | M | | 9.2.13 | | YES | ignore |
| Failare cell PCI | M | | INTEGER | Physital Cell Identifier | YES | ignore |
| | | | (0..503, ...) | | | |
| Failure cell TAC | | | | | | |
| Re-establishment | M | | ECGI | | YES | ignore |
| cell ECGI | | | 9.2.14 | | | |
| C-RNTI | M | | BIT STRING | C-RNTI contained in the RRC | YES | ignore |
| | | | (SIZE (16)) | Re-establishment Request | | |
| | | | | message (TS 36.331) | | |
| ShortMAC-I | O | | BIT STRING | ShortMAC-1 contained in the | YES | ignore |
| | | | (SIZE (16)) | RRC Re-establishment Request | | |
| | | | | message (TS 36.331) | | |
| UE RLF Report | O | | OCTET | RLF-Report-r9 IE contained in | YES | ignore |
| Container | | | STRING | the UEInformationResnense | | |
| | | | | message (TS 36.331) | | |
| RRC Conn Setup | O | | ENUMERATED | Included if the RLF Report | YES | reject |
| indicator | | | (RRCConn | within the UE RLF Report | | |
| | | | | Container IE is retrieved after | | |
| | | | Setup, ...) | an RRC connection setup or an | | |
| | | | | incoming successful handover | | |
| RRC Conn | O | | ENUMERATED | The Reesblishment Cause in | YES | ignore |
| Reestab Indicator | | | (reconfiguration | RRCConnectionReestablishment | | |
| | | | Failure, | Requestmessage (TS 36.331) | | |
| | | | handoverFailure, | | | |
| | | | otherFailure, ...) | | | |
| UE RLF Report | O | | OCTET | RLF-Report-v9e0 IE contained | YES | ignore |
| Container for | | | STRING | in the UEinformationResponse | | |
| extended hands | | | | message (TS 36.331) | | |

TABLE 17
HANDOVER REPORT
(This message is sent by the eNB1 to report a handover failure event or other
critical mobility problem. Direction: eNB₁ → eNB₂)

| | | | IE type and | | | Assigned |
|---|---|---|---|---|---|---|
| IE/Group Name | Presence | Range | reference | Semantics description | Criticality | Criticality |
| Message Type | M | | 9.2.13 | | YES | ignore |
| Handover Report | M | | ENUMERATED | | YES | ignore |
| Type | | | (HO too early, | | | |
| | | | HO to | | | |
| | | | wrong cell, ..., | | | |
| | | | InterRAT | | | |
| | | | ping-pong) | | | |
| Handover Cause | M | | Cause | Indicates handover | YES | ignore |
| | | | 9.2.6 | cause employed for | | |
| | | | | handover from eNB₂ | | |
| Source cell ECGI | M | | ECGI | ECG1 of source cell for | YES | Ignore |
| | | | 9.2.14 | handover procedure (in | | |
| | | | | eNB₂) | | |
| Source cell TAC | | | | | | |
| Failure cell ECGI | M | | ECGI | ECGI of target cell for | YES | ignore |
| | | | 9.2.14 | handover procedure (in | | |
| | | | | eNB₁) | | |
| Failure cell TAC | | | | | | |
| Re-establishment cell | C- | | ECGI | ECGI of cell where UE | YES | ignore |
| ECGI | ifHandover | | 9.2.14 | attempted re- | | |
| | ReportType | | | establishment | | |
| | HoToWrong | | | | | |
| | Cell | | | | | |
| Re-estblishment cell | | | | | | |
| TAC | | | | | | |
| Target cell in UTRAN | C- | | OCTET | Encoded according to | YES | ignore |
| | itHandover | | STRING | UTRAN Cell ID in the | | |
| | ReportType | | | Last Visited UTRAN | | |
| | InterRATping | | | Cell Information IE, as | | |
| | pong | | | defined in in TS 25.413 | | |
| Source cell C-RNTI | O | | BIT STRING | C-RNTI allocated at the | YES | ignore |
| | | | (SIZE (16)) | source eNB (in eNB₂) | | |
| | | | | contained in The AS- | | |
| | | | | config (TS 36.331). | | |
| Mobility information | | | BIT STRING | Information provided in | YES | ignore |
| | | | (SIZE (32)) | the HANGOVER | | |
| | | | | REQUEST message | | |
| | | | | from eNB₂. | | |
| UE RLF Report | O | | OCTET | The UE RLF Report | YES | ignore |
| Container | | | STRING | Container IE received in | | |
| | | | | the RLF INDICATION | | |
| | | | | message. | | |
| UE RLF Report | O | | OCTET | The UE RLF Report | YES | ignore |
| Container for | | | STRING | Container for extended | | |
| extended bands | | | | bands IE received in the | | |
| | | | | RLF INDICATION | | |
| | | | | message. | | |

TABLE 18
CELL ACTIVATION REQUEST
(This message is sent by an eNB to a peer eNB to request a previously
switched-off cell/s to be re-activated. Direction: eNB₁ → eNB₂)

| | | | | Seman- | | |
|---|---|---|---|---|---|---|
| | | | IE type | tics | | Assigned |
| IE/Group | Pres- | | and | descrip- | | Criti- |
| Name | ence | Range | reference | tion | Criticality | cality |
| Message | M | | 9.2.13 | | YES | reject |
| Type | | | | | GLOBAL | reject |
| Served | | 1 .. | | | | |
| Cells | | <max | | | | |
| To | | Celline | | | | |
| Activate | | NB> | | | | |
| >ECGI | M | | 9.2.14 | | — | — |
| >TAC | | | | | | |

TABLE 19
CELL ACTIVATION RESPONSE
(This message is sent by an eNB to a peer eNB to indicate
that one or more cell(s) previously switched-off
has(have) been activated. Direction: eNB₂ → eNB₁)

| | | | | Seman- | | |
|---|---|---|---|---|---|---|
| | | | IE type | tics | | Assigned |
| IE/Group | Pres- | | and | descrip- | | Criti- |
| Name | ence | Range | reference | tion | Criticality | cality |
| Message | M | | 9.2.13 | | YES | reject |
| Type | | | | | | |
| Activated | | 1 .. | | | GLOBAL | ignore |
| Cell List | | <max | | | | |
| | | Celline | | | | |
| | | NB> | | | | |
| >ECGI | M | | 9.214 | | — | — |
| >TAC | | | | | | |
| Criticality | | | 9.2.7 | | YES | ignore |
| Diagnostics | | | | | | |

TABLE 20
Last Visited E-UTRAN Cell Information
(The Last Visited E-UTRAN Cell Information contains information
about a cell that is to be used for RRM purposes.)

| IE/Group | | | IE type and | Semantics | | Assigned |
|---|---|---|---|---|---|---|
| Name | Presence | Range | reference | description | Criticality | Criticality |
| Global | M | | ECGI 9.2.14 | | — | — |
| Cell ID | | | | | | |
| TAC-List | | | | | | |
| Cell Type | M | | 9.2.42 | | — | — |
| Time UE | M | | INTEGER | The duration of the time the | — | — |
| stayed | | | (0..4095) | UE stayed in the cell in | | |
| in Cell | | | | seconds. If the UE stays in | | |
| | | | | a cell more than 4095s, this | | |
| | | | | IE is set to 4095. | | |
| Time UE | O | | INTEGER | The duration of the time the | YES | ignore |
| stayed in | | | (0..40950) | UE stayed in the cell in 1/10 | | |
| Cell | | | | seconds. If the UE stays in | | |
| Enhanced | | | | IE is set to 40950. | | |
| Granularity | | | | | | |
| HO Cause | O | | Cause | The cause for the handover | YES | ignore |
| Value | | | 9.2.6 | from the E-UTRAN cell. | | |

TABLE 21
MDT Configuration
(The IE defines the MDT configuration parameters.)

| | | | | Seman- | | |
|---|---|---|---|---|---|---|
| | | | IE type | tics | | |
| IE/Group | Pres- | | and | descrip- | Criti- | Assig- |
| Name | ence | Range | reference | tion | cality | ned |
| MDT | M | | ENUME- | | — | — |
| Activation | | | RATED | | | |
| | | | (Immediate | | | |
| | | | MDT only, | | | |
| | | | Immediate | | | |
| | | | MDT and | | | |
| | | | Trace, ...) | | | |
| CHOICE | M | | | | — | — |
| Area Scope | | | | | | |
| of MDT | | | | | | |
| >Cell Based | | | | | — | — |
| >>Cell ID | | 1..<max | | | — | — |
| List | | noofCellID | | | | |
| for MDT | | forMDT> | | | | |
| >>>ECGI | M | | 9.2.14 | | — | — |
| >>> TAC | | | | | | |
| >TA Based | | | | | — | — |
| >>TA List | | 1..<max | | | — | — |
| for MDT | | noofTA | | | | |
| | | forMDT> | | | | |

TABLE 22
CoMP Hypothesis Set (This IE provides a set of CoMP hypotheses. A CoMP hypothesis
is hypothetical PRB-specific resource allocation information for a cell.)

| | | | IE type and | |
|---|---|---|---|---|
| IE/Group Name | Presence | Range | reference | Semantics description |
| CoMP Hypothesis Set | | 1 . . . <maxnoofCoMPCells> | | |
| Item | | | | |
| >Cell ID | M | | ECGI | ID of the cell for which the CoMP Hypothesis |
| | | | 9.2.14 | IE is applied. |
| >TAC | | | | |
| >CoMP Hypothesis | M | | BIT STRING | Each position in the bitmap represents a PRB |
| | | | (6 . . . 4400, . . .) | in a subframe, for which value “1” indicates |
| | | | | ‘interference protected resource’ and value “0” |
| | | | | indicates ‘resource with no utilization |
| | | | | constraints,’ which is applicable only in |
| | | | | positions corresponding to the DL direction. |
| | | | | The first bit corresponds to PRB 0 of the first |
| | | | | subframe for which the IE is valid, the second |
| | | | | bit corresponds to PRB 1 of the first subframe |
| | | | | for which the IE is valid, and so on. |
| | | | | The bit string may span across multiple |
| | | | | contiguous subframes. |
| | | | | The length of the bit string is an integer |
| | | | | (maximum 40) multiple of N_{RB}^{DL}, N_{RB}^{DL} is |
| | | | | defined in TS 36.211. |
| | | | | The CoMP hypothesis pattern is continuously |
| | | | | repeated. |

TABLE 23
RSRP Measurement Report List (This IE provides RSRP measurement
reports of UEs served by the sending eNB.)

| | | | IE type and | |
|---|---|---|---|---|
| IE/Group Name | Presence | Range | reference | Semantics description |
| RSRP Measurement Report | | 1 . . . | | |
| Item | | <maxUERepart> | | |
| >RSRP Measurement | | 1 . . . | | |
| Result | | <maxCellReport> | | |
| >>RSRP Cell ID | M | | ECGI | ID of the cell on which the RSRP |
| | | | 9.2.14 | is measured. |
| >> RSRP TAC | | | | |
| >>RSRP Measured | M | | INTEGER | Measured RSRP. |
| | | | (0 . . . 97, . . .) | Defined in TS 36.331. |
| >UE ID | O | | BIT STRING | ID assigned by eNB₂ for the DE. |
| | | | (SIZE(16)) | |

Xw Procedures—Table 24

TABLE 24
Xw SETUP REQUEST
(This message is sent by an eNB to a WT to transfer the initialization
information for a TNL association. Direction: eNB → WT)

| | | | IE type | | | |
|---|---|---|---|---|---|---|
| IE/Group | Pres- | | and | Semantics | Criti- | Assigned |
| Name | ence | Range | reference | description | cality | Criticality |
| Message Type | M | | 9.2.1 | | YES | reject |
| Global eNB ID | M | | 9.2.2 | | YES | reject |
| TAI List | | | | | | |
| >>TAI | | | | | | |
| >>>PLMN-ID | | | | | | |
| >>>TAC | | | | | | |

S1 Procedures—Tables 25 and 26

TABLE 25
PWS FAILURE INDICATION
(This message is sent by the eNB to inform the MME that
ongoing PWS operation for one or more cells
of the eNB has failed. Direction: eNB 4 MME)

| | | | | Seman- | | As- |
|---|---|---|---|---|---|---|
| | | | IE type | tics | | signed |
| IE/Group | Pres- | | and | descrip- | Criti- | Criti- |
| Name | ence | Range | reference | tion | cality | cality |
| Message | M | | 9.2.1.1 | | YES | ignore |
| Type | | | | | | |
| PWS failed | | 1..<max | | | EACH | reject |
| E-CGI List | | noofCell | | | | |
| | | sineNB> | | | | |
| >E-CGI | M | | 9.2.1.38 | | — | — |
| Global | M | | 9.2.1.37 | | YES | reject |
| eNB ID | | | | | | |
| List of TAIs | | 1 | | | YES | ignore |
| >TAI List | | 1 .. | | | EACH | ignore |
| Item | | <maxnoof | | | | |
| | | TAIs> | | | | |
| >>TAI | M | | 9.2.3.16 | | — | |

TABLE 26
Synchronisation Information
(This information element contains information concerning the cell selected as
source of synchronisation signal by the sending eNB.)

| IE/Group | | | IE type and | Semantics | | Assigned |
|---|---|---|---|---|---|---|
| Name | Presence | Range | reference | description | Critically | Criticality |
| Source | O | | INTEGER | Stratum Level of cell | | |
| Stratum | | | (0..3, ...) | selected as | | |
| Level | | | | synchronisation source, | | |
| | | | | The range of this IE is | | |
| | | | | limited to 0 . . . 2. | | |
| Listening | O | | 9.2.3.43 | Subframe pattern | | |
| Subframe | | | | where the Reference | | |
| Pattern | | | | Signals can be detected | | |
| | | | | for synchronisation. | | |
| Aggressor | | 0..1 | | List of cells for which | | |
| Cell List | | | | the muting pattern need | | |
| | | | | to be activated. | | |
| >Aggressor | | 1.. <maxnoof | | | | |
| E-CGI List | | CellsineNB> | | | | |
| >>E-CGI | | | 9.2.1.38 | | | |
| >TAI List | | 1 .. | | | | |
| | | <maxrtoof | | | | |
| | | RestartTAIs | | | | |
| >>>TAI | M | | 9.2.3.16 | | | |

M2 Procedures—Tables 27 and 28

TABLE 27
M2 SETUP REQUEST
(This message is sent by the eNB to initiate the M2 interface instance.
Direction: eNB → MCE)

| | | | | Seman- | | As- |
|---|---|---|---|---|---|---|
| | | | | tics | | signed |
| IE/Group | Pres- | | IE type and | descrip- | Criti- | Criti- |
| Name | ence | Range | reference | tion | cality | cality |
| Message Type | M | | 9.2.1.1 | | YES | reject |
| Global eNB ID | M | | 9.2.1.10 | | YES | reject |
| TAI List | | | | | | |
| >>TAI | | | | | | |
| >>>PLMN-ID | | | | | | |
| >>>TAC | | | | | | |
| eNB Name | O | | Printable | | YES | ignore |
| | | | String | | | |
| | | | (1..150,...) | | | |
| eNBMBMS | | 1 | | | YES | reject |
| Configuration | | | | | | |
| data per cell | | | | | | |
| >eNB MBMS | | 1 to | | | EACH | reject |
| Configuration | | <maxno | | | | |
| data Item IEs | | ofCells> | | | | |
| >>eNB MBMS | M | | 9.2.1.12 | | | |
| Configuration | | | | | | |
| data Item | | | | | | |

TABLE 28
ENB CONFIGURATION UPDATE
(This message is sent by the eNB to indicate that application level configuration
data has changed in the eNB.)

| IE/Group | | | IE type and | Semantics | | Assigned |
|---|---|---|---|---|---|---|
| Name | Presence | Range | reference | description | Criticality | Criticality |
| Message Type | M | | 9.2.1.1 | | YES | reject |
| Global eNB ID | O | | 9.2.1.10 | | YES | reject |
| TAI List | | | | | | |
| >>TAI | | | | | | |
| >>>PLMN-ID | | | | | | |
| >>>TAC | | | | | | |
| eNB Name | O | | Printable | | YES | ignore |
| | | | String | | | |
| | | | (1..150,...) | | | |
| eNB MBMS Configuration | | 0..1 | | | YES | reject |
| data per cell | | | | | | |
| >eNB MBMS Configuration | | 1 to | | | EACH | reject |
| data per cell Item IEs | | <maxno | | | | |
| | | ofCells> | | | | |
| >>CHOICE MBMS | M | | | | | |
| Configuration Update | | | | | | |
| >>>Configuration Data | | | | | | |
| >>>>eNB MBMS | | | 9.2.1.12 | | | |
| Configuratian data Item | | | | | | |
| >>>E-CGI | | | | | | |
| >>>>E-UTRAN CGI | | | 9.2.1.11 | | | |

E-SMLC Procedures—Table 29

TABLE 29
Network Element
(This parameter identifies the source or destination of the message.
The network element is identified by association
with either an eNB ID or the identity of an E-SMLC.)

| IE/ | | | IE type | | | As- |
|---|---|---|---|---|---|---|
| | | | | | | signed |
| Group | Pres- | | and | Semantics | Criti- | Criti- |
| Name | ence | Range | reference | description | cality | cality |
| CHOICE | M | | | | | |
| Network | | | | | | |
| Element | | | | | | |
| >Global | | | | The global | | |
| eNB ID | | | | identity of | | |
| | | | | the eNB | | |
| >>PLMN | | | 7.4.27 | | | |
| Identity | | | | | | |
| <<eNB ID | | | 7.4.29 | | | |
| >>TAI List | | | | | | |
| >>>TAI | | | | | | |
| >>>>PLMN- | | | | | | |
| ID | | | | | | |
| >>>>TAC | | | | | | |
| >E-SMLC | | | INTEGER | The identity | | |
| Identity | | | (0..255) | of the E-SMLC | | |
| | | | | (an index to | | |
| | | | | identify an | | |
| | | | | specific E-SMLC | | |
| | | | | among all the | | |
| | | | | available | | |
| | | | | E-SMLCs | | |
| | | | | in the network) | | |

The communication apparatus may comprise the base station to which the identifier and tracking area relate. In this case, the communication apparatus may comprise a first base station, and the controller may be configured to: obtain i) a further identifier for identifying a second base station and a cell operated by the second base station and ii) a further tracking area code associated with an area in which a plurality of base stations operate including the second base station to which the further identifier relates.

Alternatively, the communication apparatus may comprise a first base station and the base station to which the identifier and tracking area relate may be a second base station. In this case, the controller may be configured to look up, based both on the obtained identifier and on the tracking area code, a transport network layer address for the second base station.

The controller may be configured to use the obtained identifier together with the tracking area code for identifying the base station in an X2 procedure involving the base station. The controller may also be configured to use the obtained identifier together with the tracking area code for identifying the base station in at least one of: an automatic neighbour relation (ANR) procedure relating to the base station; an operation and maintenance (O&M) procedure relating to the base station; an S1 procedure relating to the base station; an Xw procedure relating to the base station; an M2 procedure relating to the base station; and an evolved serving mobile location centre (E-SMLC) procedure relating to the base station.

The controller may be configured to generate, as part of said subsequent procedure, a signalling message comprising said obtained identifier and said tracking area code, wherein the tracking area code may be located in an appropriately formatted information element that is arranged to distinguish the base station to which the obtained identifier relates from another base station that has another identifier that matches the obtained identifier.

The obtained identifier and said tracking area code may be stored in association with one another in a neighbour relation table (NRT) table and may be arranged such that the tracking area code can be used to distinguish the base station to which the obtained identifier relates from another base station that has another identifier that matches the obtained identifier.

The communication apparatus may comprise one of: a mobility management entity (MME); an operation and maintenance (O&M) entity; an X2 gateway; a multi-cell/multicast coordination entity (MCE); an evolved serving mobile location centre (E-SMLC); and a wireless local area network (WLAN) termination node.

Various other modifications will be apparent to those skilled in the art and will not be described in further detail here.

The following is a detailed description of the ways in which the above described embodiments may be implemented in the currently proposed 3GPP standards. Whilst various features are described as being essential or necessary, this may only be the case for the proposed 3GPP standard, for example due to other requirements imposed by the standard. These statements should not, therefore, be construed as limiting the present invention in any way.

### 1 Introduction

Demand of increasing small cell sizes and the need to provide cellular services to large areas while at the same time maintaining globally unique eNB-ID and cell-ID put network operators to a test. The natural solution to this problem is to increase the number of bits used by eNB-ID/ECGI. However, this can come at a heavy cost of backward compatibility problem. Flexibly changing the number of bits to denote eNB-ID without changing the total number of bits used to construct ECGI was presented in RAN3 #91bis while another option to use more than 1 PLMN-ID by the same mobile operator was objected by an operator on the grounds that it can lead to heavy cost due to USIM change.

In the light of this, the objective of this paper is to explore whether any solution is possible that can meet the above-mentioned contradictory requirements.

### 2 Discussion

Increasing eNB-ID beyond 20 bits can be a natural result of decreasing cell sizes and increasing service coverage. In contrary, it is yet to be figured out why there is a need to increase the cells beyond 256 per eNB.

Observation 1: Increasing eNB-ID size is the need of the time—however, not the the number of cells per eNB.

Proposal 1: RAN3 is respectfully requested to study in terms of use case scenario that necessitates the number of cells to be increased beyond 256 per eNB.

Flexibly changing the number of bits used to construct eNB Id while keeping the total ECGI length can cause lots of backward compatibility and inter-operability issues. When an operator needs to increase both eNB-ID and cell-ID, it cannot be a solution.

On the other hand, using more than one PLMN-ID cannot be a solution too as this may require an operator to replace USIM—it is an expensive process.

In the light of this, it is important to explore whether there exists any ready-made Solution that can meet all the contradictory requirements as outlined in Section 1 above. For instance, tracking area code (TAC) is mostly available in many of the messages exchanged or broadcast. Hence, combined use of carefully assigned TACs per eNB and ECGI can make unique combinations.

Proposal 2: RAN3 is respectfully requested to study whether a combined use of TAC and ECGI can solve the problem faced by Operators.

### 3 Conclusion and Proposals

This paper Analyses in terms of how to meet the competing demands of an operator to increase the number of eNBs in the network while maintaining global uniqueness and without causing backward compatibility. With its basic Analysis, it further makes the following Observation and proposals:

Observation 1: Increasing eNB-ID size is the need of the time—however, not the number of cells per eNB.

Proposal 1: RAN3 is respectfully requested to study in terms of use case scenario that necessitates the number of cells to be increased beyond 256 per eNB.

Proposal 2: RAN3 is respectfully requested to study whether a combined use of TAC and ECGI can solve the problem faced by Operators.

The whole or part of the example embodiments disclosed above can be described as, but limited to, the following supplementary notes.

(Supplementary note 1) Communication apparatus for a communication network, the communication apparatus comprising a controller configured to:
obtain i) an identifier for identifying at least one of a base station and a cell operated by the base station and ii) a tracking area code associated with an area in which a plurality of base stations operate including the base station to which the identifier relates; and
use the obtained identifier in combination with the tracking area code for identifying the base station in a subsequent procedure relating to that base station.

(Supplementary note 2) Communication apparatus according to Supplementary note 1, comprising the base station to which the identifier and tracking area relate.

(Supplementary note 3) Communication apparatus according to Supplementary note 2, wherein said communication apparatus comprises a first base station and wherein the controller is configured to: obtain i) a further identifier for identifying a second base station and a cell operated by the second base station and ii) a further tracking area code associated with an area in which a plurality of base stations operate including the second base station to which the further identifier relates.

(Supplementary note 4) Communication apparatus according to Supplementary note 1, wherein said communication apparatus comprises a first base station and the base station to which the identifier and tracking area relate is a second base station.

(Supplementary note 5) Communication apparatus according to Supplementary note 4, wherein the controller is configured to look up, based both on the obtained identifier and on the tracking area code, a transport network layer address for the second base station.

(Supplementary note 6) Communication apparatus according to any one of Supplementary notes 1 to 5, wherein the controller is configured to use the obtained identifier together with the tracking area code for identifying the base station in an X2 procedure involving the base station.

(Supplementary note 7) Communication apparatus according to any one of Supplementary notes 1 to 6, wherein the controller is configured to use the obtained identifier together with the tracking area code for identifying the base station in at least one of: an automatic neighbour relation, ANR, procedure relating to the base station; an operation and maintenance, O&M, procedure relating to the base station; an S1 procedure relating to the base station; an Xw procedure relating to the base station; an M2 procedure relating to the base station; and an evolved serving mobile location centre, E-SMLC, procedure relating to the base station.

(Supplementary note 8) Communication apparatus according to any one of Supplementary notes 1 to 7, wherein the controller is configured to generate, as part of said subsequent procedure, a signalling message comprising said obtained identifier and said tracking area code, wherein the tracking area code is located in an appropriately formatted information element that is arranged to distinguish the base station to which the obtained identifier relates from another base station that has another identifier that matches the obtained identifier.

(Supplementary note 9) Communication apparatus according to any one of Supplementary notes 1 to 8, wherein the obtained identifier and said tracking area code are stored in association with one another in an automatic neighbour relation, ANR, table and are arranged such that the tracking area code can be used to distinguish the base station to which the obtained identifier relates from another base station that has another identifier that matches the obtained identifier.

(Supplementary note 10) Communication apparatus according to Supplementary note 1, comprising one of: a mobility management entity, MME; an operation and maintenance, O&M, entity; an X2 gateway; a multi-cell/multicast coordination entity, MCE; an evolved serving mobile location centre, E-SMLC; and a wireless local area network, WLAN, termination node.

(Supplementary note 11) A system comprising the communication apparatus according to any one of Supplementary notes 1 to 10 and at least one user equipment.

(Supplementary note 12) A method performed by communication apparatus for a communication network, the method comprising:
obtaining i) an identifier for identifying at least one of a base station and a cell operated by the base station and ii) a tracking area code associated with an area in which a plurality of base stations operate including the base station to which the identifier relates; and
using the obtained identifier in combination with the tracking area code for identifying the base station in a subsequent procedure relating to that base station.

(Supplementary note 13) A computer program product comprising computer implementable instructions for causing a programmable computer device to perform the method according to Supplementary note 12.

While the invention has been particularly shown and described with reference to example embodiments thereof, the invention is not limited to these embodiments. It will be understood by those skilled in the art that various changes in form and details may be made therein without departing from the spirit and scope of the present invention as defined by the claims.

This application is based upon and claims the benefit of priority from United Kingdom patent application No. 1609052.4, filed on May 23, 2016, the disclosure of which is incorporated herein in its entirety by reference.

1. A method performed by communication apparatus for a communication network, the method comprising:
obtaining i) an identifier for identifying at least one of a base station and a cell operated by the base station and ii) a tracking area code associated with a tracking area in which a plurality of base stations operate including the base station to which the identifier relates; and
using the obtained identifier in combination with the tracking area code for uniquely identifying the base station within the tracking area.

2. The method according to claim 1, wherein the communication apparatus comprises the base station to which the identifier and tracking area code relate.

3. The method according to claim 2, wherein the communication apparatus comprises a first base station; and wherein the method comprises obtaining i) a further identifier for identifying at least one of a second base station and a cell operated by the second base station and ii) a further tracking area code associated with an area in which a plurality of base stations operate including the second base station to which the further identifier relates.

4. The method according to claim 1, wherein the communication apparatus comprises a first base station and the base station to which the identifier and tracking area relate is a second base station.

5. The method according to claim 4, wherein the method comprises looking up, based both on the obtained identifier and on the tracking area code, a transport network layer address for the second base station.

6. The method according to claim 1, wherein the method comprises using the obtained identifier together with the tracking area code for identifying the base station in an X2 procedure involving the base station.

7. The method according to claim 1, wherein the method comprises using the obtained identifier together with the tracking area code for identifying the base station in at least one of: an automatic neighbour relation (ANR) procedure relating to the base station; an operation and maintenance (O&M) procedure relating to the base station; an S1 procedure relating to the base station; an Xw procedure relating to the base station; an M2 procedure relating to the base station; and an evolved serving mobile location centre (E-SMLC) procedure relating to the base station.

8. The method according to claim 1, wherein the method comprises generating, as part of a subsequent procedure, a signalling message comprising the obtained identifier and the tracking area code, wherein the tracking area code is located in an appropriately formatted information element that is arranged to distinguish the base station to which the obtained identifier relates from another base station that has another identifier that matches the obtained identifier.

9. The method according to claim 1 wherein the obtained identifier and the tracking area code are stored in association with one another in an automatic neighbour relation (ANR) table and are arranged such that the tracking area code can be used to distinguish the base station to which the obtained identifier relates from another base station that has another identifier that matches the obtained identifier.

10. The method according to claim 1, wherein the communication apparatus comprises one of: a mobility management entity (MME); an operation and maintenance (O&M) entity; an X2 gateway; a multi-cell/multicast coordination entity (MCE); an evolved serving mobile location centre (E-SMLC); and a wireless local area network (WLAN) termination node.

11. The method according to claim 1, wherein the base station comprises a first base station, and wherein the method further comprises:
obtaining a further identifier for identifying at least one of a second base station and a cell operated by the second base station, wherein the further identifier is the same as the identifier for identifying the first base station, and wherein the second base station is associated with a different tracking area to the first base station; and
using the further identifier in combination with a tracking area code of the different tracking area for uniquely identifying the second base station.

12. (canceled)

13. Communication apparatus for a communication network, the communication apparatus comprising a controller configured to:
obtain i) an identifier for identifying at least one of a base station and a cell operated by the base station and ii) a tracking area code associated with a tracking area in which a plurality of base stations operate including the base station to which the identifier relates; and
use the obtained identifier in combination with the tracking area code for uniquely identifying the base station within the tracking area.

14. (canceled)
